(19) United States
(12) Patent Application Publication
(10) Pub. No.: US 2007/0072152 A1
(43) Pub. Date: Mar. 29, 2007

(54) Method for creating a temporary dental crown

(76) Inventor: Jeffrey Jaghab, Northville, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/527,006

(22) Filed: Sep. 26, 2006

Related U.S. Application Data
(60) Provisional application No. 60/720,644, filed on Sep. 26, 2005.

(51) Int. Cl. A61C 5/00

(52) U.S. Cl. 433/215

(57) ABSTRACT

A method for making a temporary dental crown is disclosed. The temporary crown material that is used includes an astringent, which forms part of the material itself, to control bleeding in the gums of the patient whereby the steps involved in the procedure are simplified and minimal time is required to perform the procedure.

### CROSS-REFERENCE TO RELATED APPLICATIONS

This application claims the benefit of U.S. provisional application Ser. No. 60/720,644 filed Sep. 26, 2005.

### BACKGROUND OF THE INVENTION

1. Field of the Invention

The invention relates to a procedure for making a dental crown or bridge using simplified method steps.

2. Background Art

In a known procedure for creating a temporary dental crown or bridge, the gum of a patient is numbed with a local anesthetic. After the patient's gum is numbed, a preliminary impression is made of the tooth that is to receive a crown. The preliminary impression is made using wax, plastic, polyvinylsiloxane, etc. In preparing a tooth for receiving the crown, the defective regions of an otherwise healthy tooth are removed by grinding, thereby leaving a robust support pedestal that will provide a secure base for the dental crown when the dental crown is secured in place by an adhesive.

After the tooth is prepared, a temporary crown is made using a temporary material that is placed on the tooth. The temporary material is placed in the preliminary impression, which acts as a holder, and then is applied to the prepared tooth and held in place until the temporary material sets up. It then is removed. After removal, it is trimmed and polished. The temporary material will be shaped like the original tooth because the holder for the temporary material is the preliminary impression. The temporary material will set-up in about one to two minutes.

Before or after the temporary material is placed on the prepared tooth, bleeding of the gums surrounding the prepared tooth is controlled by using an astringent. This stops the bleeding before an impression is made using the temporary material. A proper final impression of the tooth cannot be obtained if bleeding occurs because bleeding will cause bubbles or voids.

During the set-up time, added astringent can be used if that is necessary to stop bleeding. The astringent controls bleeding by restricting small capillaries in the patient's gum.

A final impression is made at this point in the procedure. It then is sent to a dental lab, which makes a permanent crown to replace the temporary crown.

The temporary material (temporary crown) then is cemented to the prepared surfaces of the tooth.

The need for applying the astringent following preparation of the tooth for receiving the crown is a time-consuming step in the dental crown procedure.

### SUMMARY OF THE INVENTION

The invention comprises a method for creating and applying a temporary dental crown in which the steps involved in the procedure are substantially simplified. A preliminary impression mold of a defective tooth is first created to preserve the shape and form of the patient's original tooth. The material used to form the preliminary impression mold may be selected from the group consisting of wax, plastic and polyvinylsiloxane. The tooth is then prepared by grinding the upper portions of the otherwise healthy tooth to remove defective portions and to provide a surface to which the temporary crown material can be applied.

The temporary crown material is then prepared for application to the defective tooth. The temporary crown material is selected from the group consisting of acrylic, resin and bis-gma resin, or any combination thereof. An astringent can be added at any time during mixing of the components of the temporary material. In the alternative, the astringent can be incorporated into one of the components of the temporary crown material. In either case, the astringent is an ingredient of the material itself. The astringent is selected from the group consisting of epinephrine, aluminum sulfate, ferric sulfate and any other suitable astringent. Further, the astringent is in the form selected from the group consisting of liquid, cord, paste and gel. The presence of the astringent in the temporary crown material will provide a sufficient homeostasis effect, as the astringent controls bleeding by restricting small capillaries in the patient's gums.

The temporary dental crown is then formed by placing the temporary crown material and the astringent into the preliminary impression. Then, the temporary crown material in the dental impression is placed on the exposed surface of the patient's tooth to form and set the temporary dental crown. The temporary dental drown is generally attached to the tooth using a cement.

This procedure eliminates the necessity for applying the astringent to the gums in on or more separate steps of the procedure for making the crown. The overall time required for the procedure thus is reduced significantly.

### BRIEF DESCRIPTION OF THE DRAWINGS

FIG. 1 is a schematic representation of a human tooth before crown preparation together with surrounding gum tissue shown in cross-section;

FIG. 2 is a schematic illustration of a human tooth after crown preparation, wherein bleeding in the gum area surrounding the tooth is indicated;

FIG. 3 is a schematic representation of a prepared human tooth to which temporary material is placed on the tooth using a holder for the temporary material;

FIG. 4 is a schematic representation of a human tooth that has been prepared for a crown and that is ready for an impression; and

FIG. 5 is a schematic representation of a human tooth after the impression is finished and a temporary crown is cemented in place.

### DETAILED DESCRIPTION OF THE PREFERRED EMBODIMENT(S)

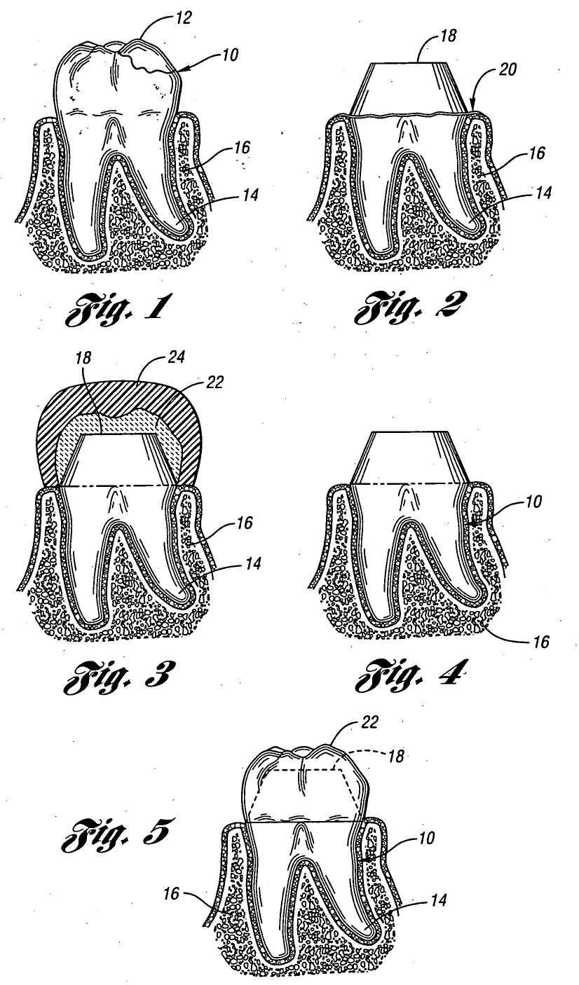

FIG. 1 shows a tooth 10 before crown preparation. It will have been determined that the tooth 10 is decayed or otherwise defective at the upper portion 12. This defective portion necessitates removing the defective portion and preparing it for the application of a permanent replacement. FIG. 1 also shows tooth roots 14 and surrounding gum tissue 16. The gum tissue 16 surrounds the entire perimeter of the tooth roots 14.

Before preparing a permanent replacement for the defective portion, a preliminary impression mold 24 of the tooth with the defective portion must be formed. The preliminary impression mold 24 is made using wax, plastic, polyvinylsiloxane or other suitable materials. The preliminary impression mold 24 is formed by placing preliminary impression material over the defective tooth 10 thereby forming an impression in the shape of the defective tooth 10.

FIG. 2 shows the tooth 10 after it has been prepared for receiving a crown. The defective portions at 12 are removed by grinding of an otherwise healthy tooth to form a mounting surface 18. Typically, the surface of the gum tissue surrounding the tooth 10 will exhibit bleeding, as illustrated at 20. In order to effectively create a permanent replacement for the defective tooth 10, it is necessary to control this bleeding.

FIG. 3 shows temporary crown material at 22. The temporary crown material 22 is first mixed and then placed in the preliminary impression mold 24. The temporary crown material 22 is made using acrylic, resin, bis-gma resin, or any combination thereof. An astringent, which controls bleeding by restricting small capillaries in the patient's gum, may either be added at any time during the mixing of the components of the temporary crown material 22 or incorporated into one of the components. Either way, the astringent is an ingredient of the temporary crown material 22. The astringent used may be selected from the group consisting of epinephrine, aluminum sulfate, ferric sulfate and any other suitable astringent. The astringent may be in the form selected from the group consisting of liquid, cord, paste and gel.

The preliminary impression mold 24, with the temporary crown material 22 within, is then placed over the prepared tooth 10 so that the temporary crown material 22 is in contact with the entire mounting surface 18. The preliminary impression mold 24 holds the temporary crown material 22 in place as it is applied to the prepared tooth 10. The astringent material in the temporary crown material 22 prevents the bleeding shown at 20 in FIG. 2 so that the temporary crown material 22 may be effectively formed to the tooth 10. Once formed to the tooth 10, the temporary crown material 22 hardens to form a permanent temporary crown.

If the defective portion of the tooth 10 is a chip, a portion of the preliminary impression mold 24 may be removed to create a space where the missing defective portion could not make an impression.

At this point in the procedure, after the temporary crown is fitted by grinding and polishing, a final impression is made, which is sent to the dental lab. The temporary crown is then cemented in place with temporary cement until the permanent crown is available to be permanently attached to the prepared tooth 10.

FIG. 4 shows a prepared tooth 10 after the temporary crown material 22 has been removed. The finished permanent temporary crown is indicated in FIG. 5.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for creating and applying a temporary dental crown comprising:
(a) creating a preliminary impression mold of a defective tooth;
(b) grinding the upper portions of the defective tooth to remove defective portions;
(c) preparing a temporary crown material with an astringent for application to the defective tooth;
(d) forming the temporary dental crown by placing the temporary crown material and the astringent into the preliminary impression; and
(e) applying the temporary dental crown to the defective tooth.

2. A method for creating and applying a temporary dental crown comprising:
(a) creating a preliminary impression mold of a defective tooth;
(b) grinding the upper portions of the defective tooth to remove defective portions;
(c) preparing a temporary material for application to the defective tooth;
(d) mixing an astringent into the temporary crown material;
(e) forming the temporary dental crown by placing the temporary crown material and the astringent into the preliminary impression mold; and
(f) applying the temporary dental crown to the defective tooth.

3. A method for creating and applying a temporary dental crown as defined in claim 1 wherein the astringent is selected from a group consisting of epinephrine, aluminum sulfate, ferric sulfate and any other suitable astringent.

4. A method for creating and applying a temporary dental crown as defined in claim 1 wherein the astringent is in a form selected from a group consisting of liquid, cord, paste and gel.

5. A method for creating and applying a temporary dental crown as defined in claim 1 wherein the preliminary impression mold is selected from a group consisting of wax, plastic and polyvinylsiloxane.

6. A method for creating and applying a temporary dental crown as defined in claim 1 wherein the temporary crown material is selected from a group consisting of acrylic, resin and bis-gma resin, or any combination thereof.

7. A method for creating and applying a temporary dental crown comprising:
(a) creating a preliminary impression mold of a defective tooth;
(b) grinding the upper portions of the defective tooth to remove defective portions;
(c) preparing a temporary crown material for application to the defective tooth having at least two components;
(d) incorporating an astringent into at least one of the at least two components of the temporary crown material;
(e) forming the temporary dental crown by placing the temporary crown material and the astringent into the preliminary impression; and
(f) applying the temporary dental crown to the defective tooth.

8. A method for creating and applying a temporary dental crown as defined in claim 6 wherein the astringent is selected from a group consisting of epinephrine, aluminum sulfate, ferric sulfate and any other suitable astringent.

9. A method for creating and applying a temporary dental crown as defined in claim 6 wherein the astringent is in a form selected from a group consisting of liquid, cord, paste and gel.

10. A method for creating and applying a temporary dental crown as defined in claim 6 wherein the preliminary impression mold is selected from a group consisting of wax, plastic and polyvinylsiloxane.

11. A method for creating and applying a temporary dental crown as defined in claim 6 wherein the temporary crown material is selected from a group consisting of acrylic, resin and bis-gma resin, or any combination thereof.
